(19) United States
(12) Patent Application Publication
(10) Pub. No.: US 2019/0016183 A1
(43) Pub. Date: Jan. 17, 2019

(54) INTEGRATED HITCH SYSTEM

(71) Applicant: HORIZON GLOBAL AMERICAS INC., Plymouth, MI (US)

(72) Inventors: Mark Scruggs, Northville, MI (US); Jacob Belinky, Carleton, MI (US); David J. Brodie, Canton, MI (US); Stephen Gerald Sieczka, Brighton, MI (US); Brian Wayne Ward, Swartz Creek, MI (US)

(21) Appl. No.: 16/035,151

(22) Filed: Jul. 13, 2018

Related U.S. Application Data
(60) Provisional application No. 62/532,045, filed on Jul. 13, 2017.

(51) Int. Cl. B60D 1/145

(52) U.S. Cl. CPC B60D 1/145; B22D 25/00

(57) ABSTRACT

A hitch receiver assembly may include a body and a hitch receiving portion comprising an opening and extending from the body. The hitch receiver assembly may also include a crossbar receiving portion extending from the body opposite the hitch receiving portion, where the crossbar receiving portion comprises opposed crossbar receiving openings, each of the crossbar receiving openings having a non-linear attachment profile.

### CROSS-REFERENCE TO RELATED APPLICATION

This application claims the benefit of U.S. Provisional Patent Application No. 62/532,045, entitled “INTEGRATED, CAST HITCH SYSTEM,” filed on Jul. 13, 2017, which is hereby incorporated in its entirety by reference.

### FIELD OF INVENTION

The present disclosure is generally related to a towing system and, more particularly, to integrated hitch system attachable to a connecting member of a towing vehicle.

### BACKGROUND

Hitch assemblies for towing vehicles such as trucks generally include a hitch receiver rigidly attached to the towing vehicles. The hitch receiver may need to be attached to the towing vehicles generally using a number of components. In order to ensure towing strength and stability associated with the attachment, these components are required to be assembled and welded with precise dimensions and tolerances.

As shown in FIG. 1, a typical assembly of an exemplary hitch mounting system 10 includes a hitch drawbar receiver 20, a hitch receiver reinforcement 30, a safety chain plate 40, a hitch receiver to hitch reinforcement 50, a hitch receiver to hitch crossbar dropper 60, and a crossbar 70. Typical manufacturing/assembly process of prior art versions may need precise dimensioning of all the components listed above. However, due to the size and weight of many components, such precise dimensioning and welding of all the components may be difficult to achieve.

These issues may be solved by using an integrated, one-piece hitch mounting system. In this manner, necessary dimensions for the hitch mounting system 10 can be maintained relative to one another due to any possible tolerance issues. Further still, such integrated hitch system may avoid certain manufacturing processes or specific design choices. Such a one-piece integrally hitch system may provide a strong, unitized construction. The ductile iron material may exhibit the necessary strength and other desirable physical characteristics required to result in significant increases of towing capacity over prior art hitch bars of similar size and shape fabricated from cold rolled and forged steel components.

Therefore, there is a need for a hitch mounting system that may account for and avoid the precise dimensioning and the tolerance stack up. It would be desirable to have the integrated hitch system to provide improvements to the identified issues.

### BRIEF DESCRIPTION OF THE DRAWINGS

Operation of the present teachings may be better understood by reference to the detailed description taken in connection with the following illustrations. These appended drawings form part of this specification, and any written information in the drawings should be treated as part of this disclosure. In the same manner, the relative positioning and relationship of the components as shown in these drawings, as well as their function, shape, dimensions, and appearance, may all further inform certain aspects of the invention as if fully rewritten herein.

In the drawings:

FIG. 1 is a perspective view of a prior art hitch mounting system;

FIG. 2 is a perspective view of an embodiment of an exemplary integrated cast hitch bar system;

FIG. 3 is a perspective view of an embodiment of an integrated cast hitch bar receiver;

FIG. 4A is a top view of an embodiment of an integrated cast hitch bar receiver;

FIG. 4B is a front view of an embodiment of an integrated cast hitch bar receiver;

FIG. 4C is a rear-side view of an embodiment of an integrated cast hitch bar receiver;

FIG. 5 is a perspective view an embodiment of an integrated cast hitch bar receiver incorporating a height adapting portion;

FIG. 6A is a top view of an embodiment of an integrated cast hitch bar receiver;

FIG. 6B is a front view of an embodiment of an integrated cast hitch bar receiver;

FIG. 6C is a side view of an embodiment of an integrated cast hitch bar receiver; and

FIG. 7 is a perspective view of an assembly process with an exemplary hitch mounting system according to certain aspects of the instant disclosure.

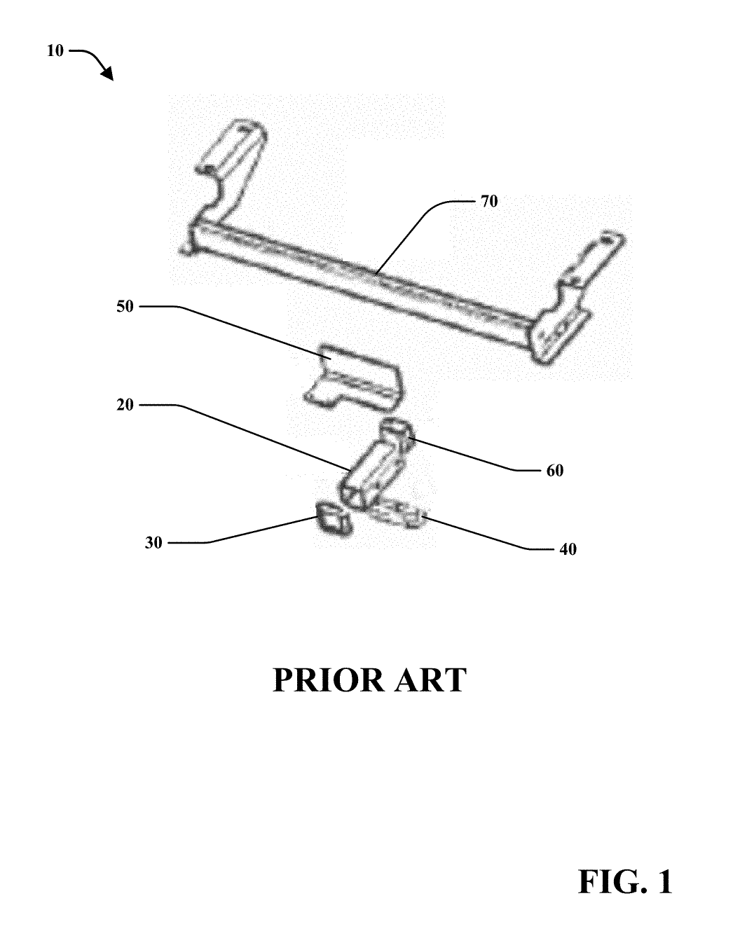

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that the various embodiments described herein may include other components and/or functionality, such those from other described embodiments herein. It is further noted that while various embodiments refer to an integrated cast hitch system, various other systems may be utilized in view of embodiments described herein. Further, the present system may include a variety of components, not limited to the components discussed below. Still further, while the present embodiments of the hitch receiver assembly are described as being cast, they may also be formed in different methods such as forging, 3D printing or the like such that they are monolithically formed as a unitary member and may be formed without welding.

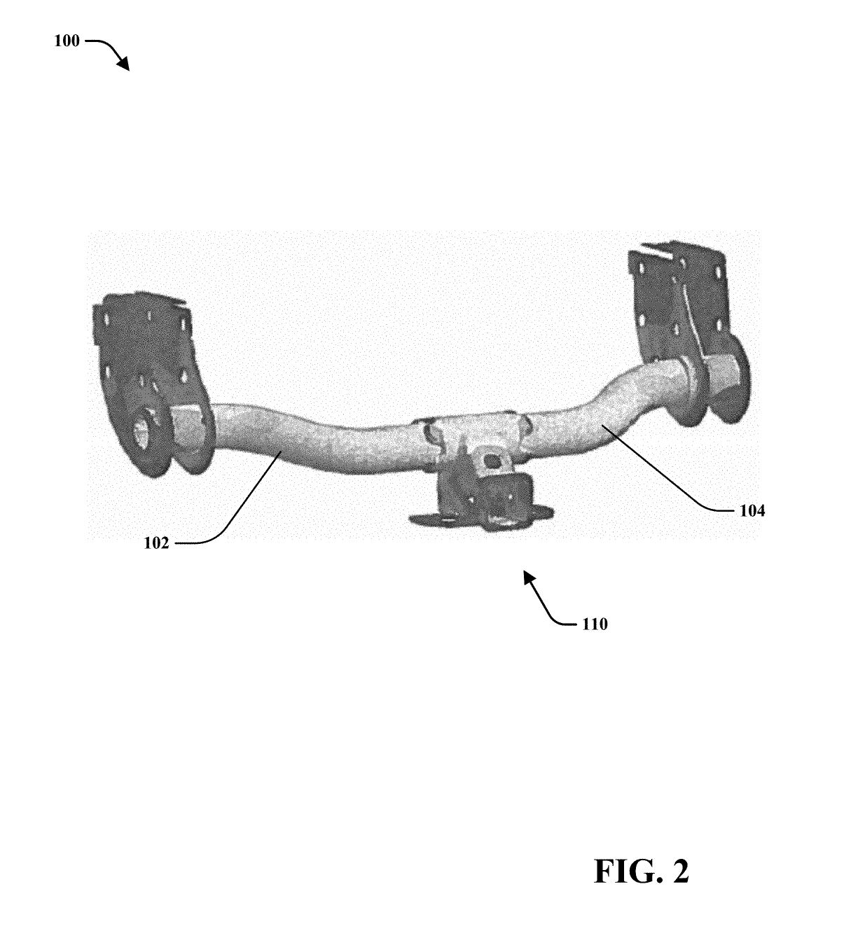

FIG. 2 illustrates an embodiment of hitch system 100 in accordance with the instant disclosure. The hitch system 100 may include crossbar members 102, 104 and an integrated casted, forged, 3D printed or the like hitch receiver assembly 110. The crossbar members 102, 104 may be substantially mirror images of one another. The hitch receiver assembly 110 may be monolithically formed cast assembly as a single piece. Such a one-piece cast (forged or 3D printed) hitch receiver assembly 110 may provide a strong and unitized construction. By way of a non-limiting example, ductile iron may be used to exhibit the necessary strength and other desirable physical characteristics required to result in a potential for increased towing capacity. The crossbar members 102, 104 may be generally tubular and may be formed of steel or other appropriate metals and/or alloys. In one embodiment described herein, three separate components 102, 104, 110 may be formed separately and then welded together for the cast hitch system 100. The crossbar members 102, 104 may be of any appropriate cross-sectional shape, including, without limitation, the cross-sectional shape may comprise circular, oval, square, rectangular or the like. Further, while the disclose contemplates a one-piece cast hitch receiver assembly 110, the hitch receiver assembly 110 may generally be formed as a one-piece cast hitch receiver having apertures being machined therein through a subsequent operation, a safety chain tie down portion or portions may be machined or welded thereon in a subsequent operation, and a hitch opening reinforcement portion may be attached through a subsequent operation or may be formed with the rest of the hitch receiver.

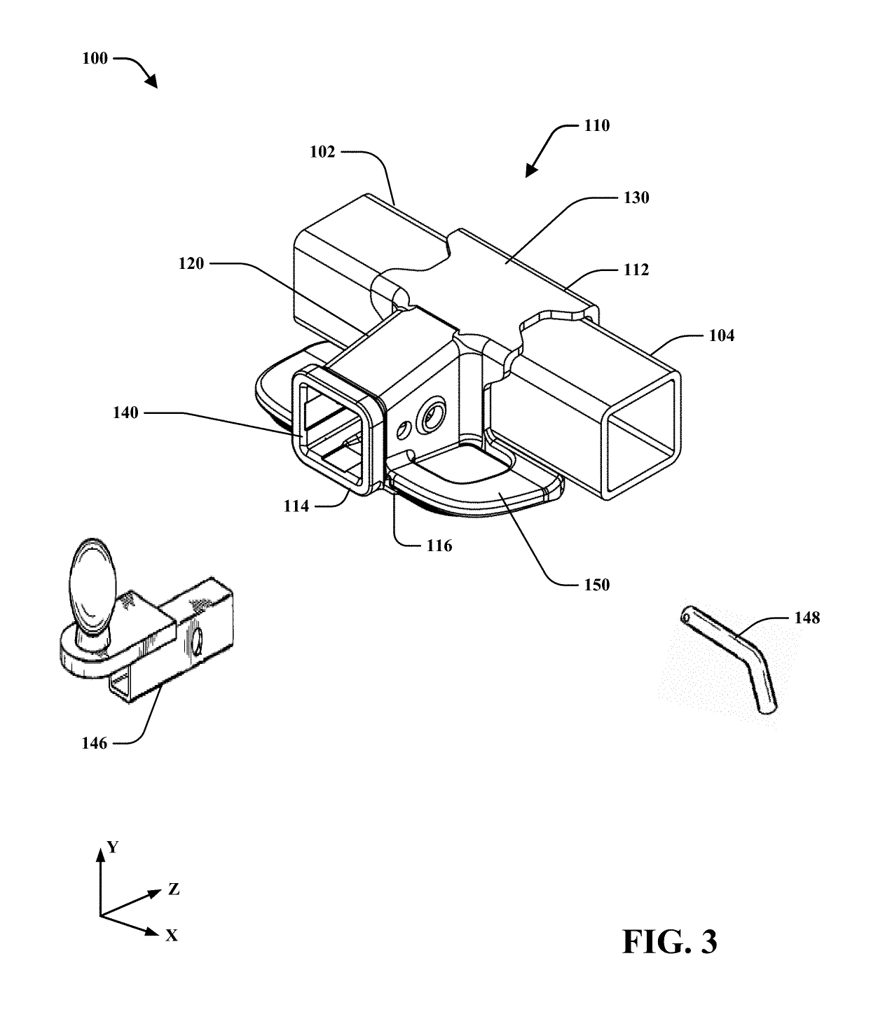

With respect to FIG. 3, the hitch receiver assembly 110 may be formed with a body 120 having a crossbar receiving portion 130, a hitch ball mount receiving portion 140, and a safety chain tie-down member or members 150. The hitch receiver assembly 110 may also include a crossbar side (or a vehicle attachment portion) 112, an opposite hitch receiving side 114, a bottom side 116, and a top side 118.

The body 120 may be manufactured by forming a sheet-metal such as a monolithic member or may be formed through a subsequent forming operation, such as welding the components together. In some embodiments, the body 120 may be formed such as through extruding. By way of a non-limiting example, the body 120 may be extruded as a single piece, which may result in the body 120 being a one-piece hitch bar receiver. Further, the body 120 may be formed such as through casting, which may result in the body 120 being a one-piece integrated cast hitch bar receiver. The present teachings, however, are not limited to the formation processes described herein. Any appropriate formation process is contemplated herein. However, it should be understood that the hitch receiver assembly 110 may be formed as a monolithic, unitary member such as through casting as a preferred approach.

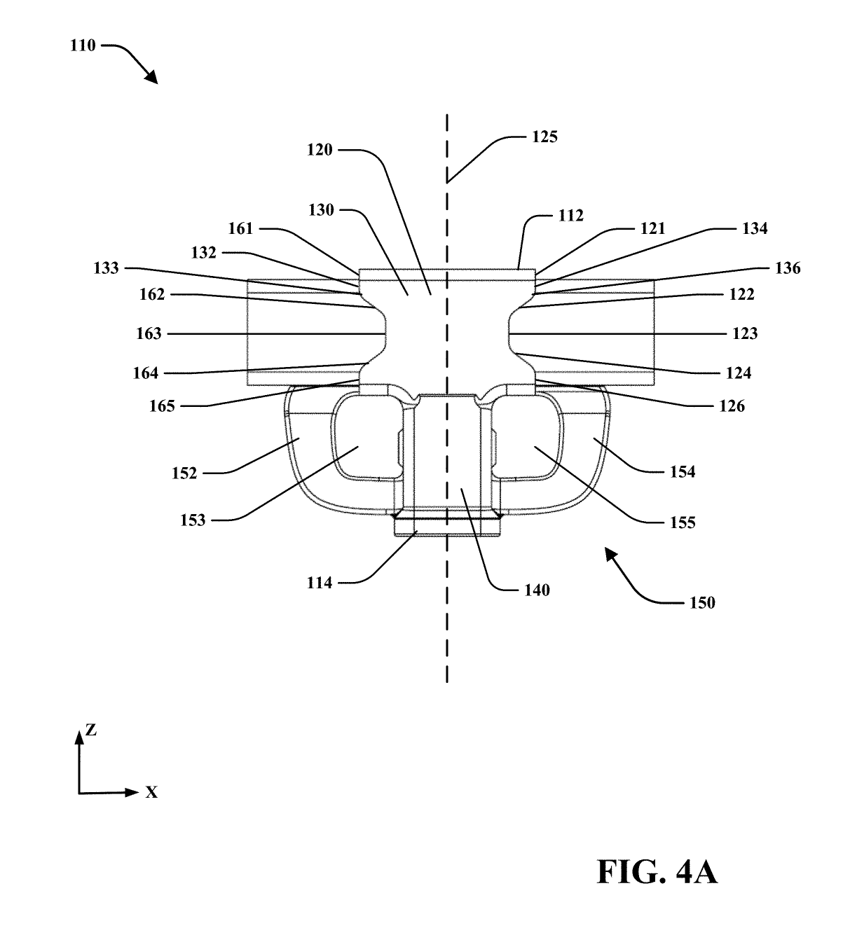

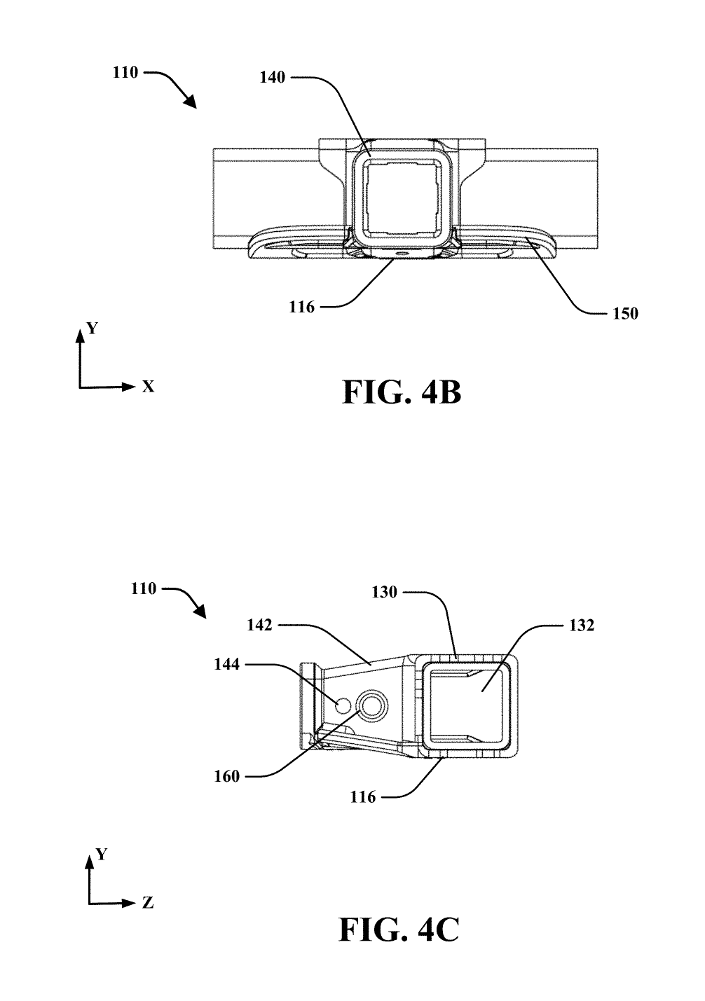

As shown in FIGS. 4A-4C, the crossbar receiving portion 130 may be positioned at the crossbar side 112 and may include a generally square or rectangular shape configured to be operatively inserted into the crossbar members 102, 104. In particular embodiment shown in FIG. 4C, the crossbar receiving portion 130 may include a generally square shape. The present teachings, however, are not limited to this shape. Any appropriate shape may be utilized, such as one that is generally circular, oval, rectangular and the like and may include an additional cut-out and the like.

As illustrated by FIG. 4A, the crossbar receiving portion 130 may be connected with the crossbar members 102, 104 and monolithically formed therewith at crossbar receiving ends 132, 134. The crossbar receiving ends 132, 134 may be generally perpendicularly related to the hitch receiving side 114. The crossbar receiving portion 130 may further include an attachment profile 133, 136 positioned along the crossbar receiving ends 132, 134, respectively. The attachment profiles 133, 136 may be generally non-linear. The attachment profiles 133, 136 may be different, similar, identical or only slightly different. In one embodiment, one of the attachment profiles 133, 136 may be linear while the other of the attachment profiles 133, 136 may be non-linear. The generally non-linear profile may be from the perspective of the entire circumference or a part thereof, i.e., only a portion of the circumference of the crossbar receiving ends 132, 134 may be non-linear. As the crossbar receiving ends 132, 134 are openings into which the crossbar members 102, 104 may be inserted, the circumference of the openings generally form the attachment profiles 133, 136.

By adding the attachment profiles 133, 136 to the crossbar receiving ends 132, 134, the attachment profiles 133, 136 may help position the crossbar receiving portion 130 and the crossbar members 102, 104 in an appropriate and operative position so that they may be welded or otherwise attached together. The attachment profiles 133, 136 may further distribute the vertical, longitudinal, and transverse compression and tension created by any attached components (and the loads associated therewith) across the vehicle frame as equally and/or evenly as is feasible. Any variation of these configurations is contemplated hereby. In particular, the attachment profile 136 may comprise a non-linear profile, i.e., the attachment profiles 133, 136 are not entirely perpendicular to the hitch receiving side 114 and/or the cross bar side 112.

In an exemplary embodiment, the attachment profile 136 may include a first portion 121 that may run generally perpendicular to the cross bar side 112 and then a second portion 122 that curves inward toward a center axis 125 of the body 120 or more specifically, the hitch receiver assembly 110, which forms a wall of a trough. The attachment profile 136 may further include a third portion 123 which may run from the second portion 122 and may be generally perpendicular to the cross bar side 112 (i.e., the third portion 123 may be generally parallel with the first portion 121). The third portion 123 may form a bottom portion of the trough. The attachment profile 136 may further include a fourth portion 124, which runs from the third portion 123. The fourth portion 124 may comprise a curved portion similar in shape to that of the second portion 122, except that it may curve away from the center axis 125. The fourth portion 124 may be non-linear, i.e., it is curved and not perpendicular to the cross bar side 112. The attachment profile 136 may include a fifth portion 126 may be of a similar configuration to the first portion 121. The fifth portion 126 may run from the fourth portion 124. The fifth portion 126 may run generally perpendicular to the cross bar side 112. While one side of what is generally four sides of the attachment profile 136 is described above, each of the remaining sides may have a generally similar profile or any one of the sides may have any other generally non-linear profile, including, without limitation, a trough shape, generally curved, partially curved, zig-zagged, or any other non-linear shape, which may be different.

The attachment profile 133 may comprise a mirror of the profile of the attachment profile 136. For example, the attachment profile 133 may include a first portion 161 that may run generally perpendicular to the cross bar side 112 and then a second portion 162 that curves inward toward the center axis 125 of the body 120 or more specifically, the hitch receiver assembly 110, which forms a wall of a trough. The attachment profile 133 may further include a third portion 163 which may run from the second portion 162 and may be generally perpendicular to the cross bar side 112 (i.e., the third portion 163 may be generally parallel with the first portion 161). The third portion 163 may form a bottom portion of the trough. The attachment profile 133 may further include a fourth portion 164, which runs from the third portion 163. The fourth portion 164 may comprise a curved portion similar in shape to that of the second portion 162, except that it may curve away from the center axis 125. The fourth portion 164 may be non-linear, i.e., it is curved and not perpendicular to the cross bar side 112. The attachment profile 133 may include a fifth portion 165 may be of a similar configuration to the first portion 161. The fifth portion 165 may run from the fourth portion 164. The fifth portion 165 may run generally perpendicular to the cross bar side 112. While one side of what is generally four sides of the attachment profile 133 is described above, each of the remaining sides may have a generally similar profile or any one of the sides may have any other generally non-linear profile, including, without limitation, a trough shape, generally curved, partially curved, zig-zagged, or any other non-linear shape, which may be different.

The attachment profiles 133, 136 taken together generally form an hour-glass shape. While the hour-glass shape is shown, the attachment profiles 133, 136 may also be of any non-linear shape, including, without limitation, generally curved, partially curved, zig-zagged, or any other non-linear shape. Further still, while the attachment profiles 133, 136 may be a generally mirrored shape, the present teachings are not limited to such. The shapes of the attachment profiles 133, 136 may be of different shapes from one another. The attachment profiles 133, 136, which are described above, may be mirrored on an opposing side of the cross bar receiving ends 132, 134. Alternatively, the attachment profiles on the bottom portion of the opposing side of the cross bar receiving ends 132, 134 may be of a different non-linear shape, including, without limitation generally curved, partially curved, zig-zagged, or any other non-linear shape. Further still, on the perpendicular side portions of the cross bar receiving ends 132, 134, the attachment profiles on both sides may be substantially identical non-linear shape, such as that described above for the attachment profiles 133, 136 or a different non-linear shape, including, without limitation, generally curved, partially curved, zig-zagged, or any other non-linear shape. In other words, the openings at ends of the cross bar receiving ends 132, 134 into which the crossbar members 102, 104 are insertable may have a circumference that is generally non-linear, including, without limitation the shape of the attachment profiles 133, 136 described above, or generally curved, partially curved, zig-zagged, or any other non-linear shape. In some embodiments, the opposed sides may be generally similar to one another, e.g., the top and bottom portions may be similar whereas the first and second sides may be similar. The top and bottom portions may in some embodiments be similar to the first and second sides of they may be different. Further, the first and second sides in some embodiments may be generally linear while the top and bottom portions may be generally non-linear, i.e., the shape of the attachment profiles 133, 136 described above, or generally curved, partially curved, zig-zagged, or any other non-linear shape.

The non-linear shape of the attachment profiles 133, 136 may provide additional area for the body 120 to be welded to the crossbar members 102, 104. This may further distribute the vertical, longitudinal, and transverse compression and tension created by any attached components (and the loads associated therewith) across crossbar members 102, 104 and ultimately the vehicle frame as equally and/or evenly as is feasible. This may allow the hitch receiver assembly 110 to operatively handle a higher load than the prior art versions that may include linear or straight welds between the body 120 and the crossbar members 102, 104.

The hitch receiving portion 140 may be positioned at the hitch receiving side 114 and may include a generally square shape. The hitch receiving portion 140 may be monolithically formed with the rest of the hitch receiver assembly 110, including, without limitation the body 120, such as through casting. The hitch receiving portion 140, however, may be of any appropriate shape, including, without limitation being generally circular or oval in shape. The hitch receiving portion 140 may extend from the crossbar side 112 to hitch receiving side 114 along the bottom side 116. As illustrated in FIG. 4C, the hitch receiving portion 140 may further include a structural support 142 to allow the hitch receiving portion 140 to maintain its structural orientation relative to the crossbar receiving portions 130. The structural support 142 may be formed in the hitch receiving portion 140 along the bottom and top side 116, 118. The structural support 142 may be monolithically formed with the crossbar receiving portion 130 such as through casting, forging, 3D printing or the like.

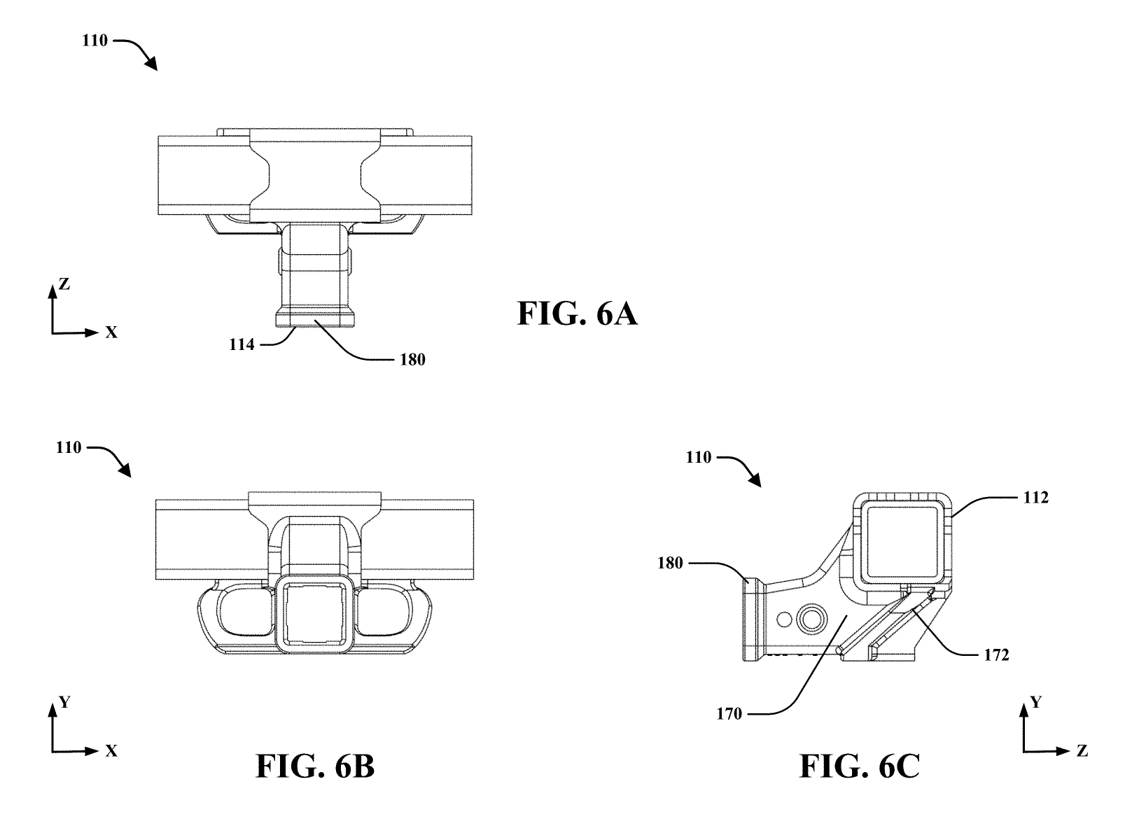

The hitch receiving portion 140 may also include apertures 144 that may receive a hitch pin 148. A hitch bar 146 may be selectively inserted into the hitch receiving portion 140. The hitch bar 146 may be any configuration that is selectively coupled to a towed vehicle such as a ball mount, clevis, or other coupling arrangement or an accessory such as a bike rack, kayak holder, ski holder or the like. The hitch bar 146 may be attached to the hitch receiving portion 140 with the hitch pin 148 that extends through the apertures 144 in the hitch receiving portion 140 and hitch bar 146. As illustrated by FIGS. 4A and 6A, the hitch receiving portion 140 may be provided at various lengths in order to optimize placement of the aperture relative to the fascia of the vehicle. The hitch receiving portion 140 may be of any appropriate size. The hitch receiving portion 140 may be sized based upon the class of towing and/or rating of the hitch receiver assembly 110. An example of such is an opening of 1.25″ for class I and II, 2″ for class III or IV, 2.5″ for class V.

In a non-limiting example illustrated in FIG. 4A, the safety chain tie-down member 150 may include first and second plates 152, 154. The first and second plates 152, 154 may be securely attached to the main body 120 by weldments or otherwise attached such as through fastening. Further still, in a preferred embodiment, the first and second plates 152, 154 may be monolithically formed with the main body 120 such as by being casted or forged as a monolithic unit. This may fixedly secure the safety chain tie-down member 150 to the body 120.

The first and second plates 152, 154 may be of any appropriate shape and size. The first and second plates 152, 154 may provide strength to the hitch receiver assembly 110. The first and second plates 152, 154 may include tie-down portions 153, 155 for receiving the tie-down device (not shown) therein. The tie-down portions 153, 155 may also help reduce the overall weight of the hitch receiver assembly 110. The first and second plates 152, 154 may be of a generally rectangular shape, but may be of any appropriate shape, including, without limitation, circular, non-circular, square, polygonal, triangular, oval or a combination of such. The first and second plates 152, 154 may be of any configuration and positioned in any appropriate location, including, without limitation on safety chain tie-down devices (not shown). The first and second plates 152, 154 may ensure that the body 120 of the hitch receiver assembly 110 is securely attached with the chain tie-down devices.

In some embodiments, the hitch receiver assembly 110 may further include protruded portions 160. The protruded portions 160 may be integrally formed within the body 120 of the hitch receiver assembly 110 to improve the stress distribution of the hitch receiver assembly 110, such as by way of a non-limiting example shown in FIG. 4C, in the hitch receiving portion 140. In some embodiments, the protruded portions 160 may be formed monolithically with the receiving portion 140 such as through casting, forging or the like. The protruded portions 160 may be positioned on either side of the receiving portion 140. Each of the protruded portions 160 may further include an aperture through which the hitch pin 148 may pass therethrough to operatively secure an operative element to the hitch receiver assembly 110, such as a ball mount, clevis, or other coupling arrangement or an accessory such as a bike rack, kayak holder, ski holder or the like.

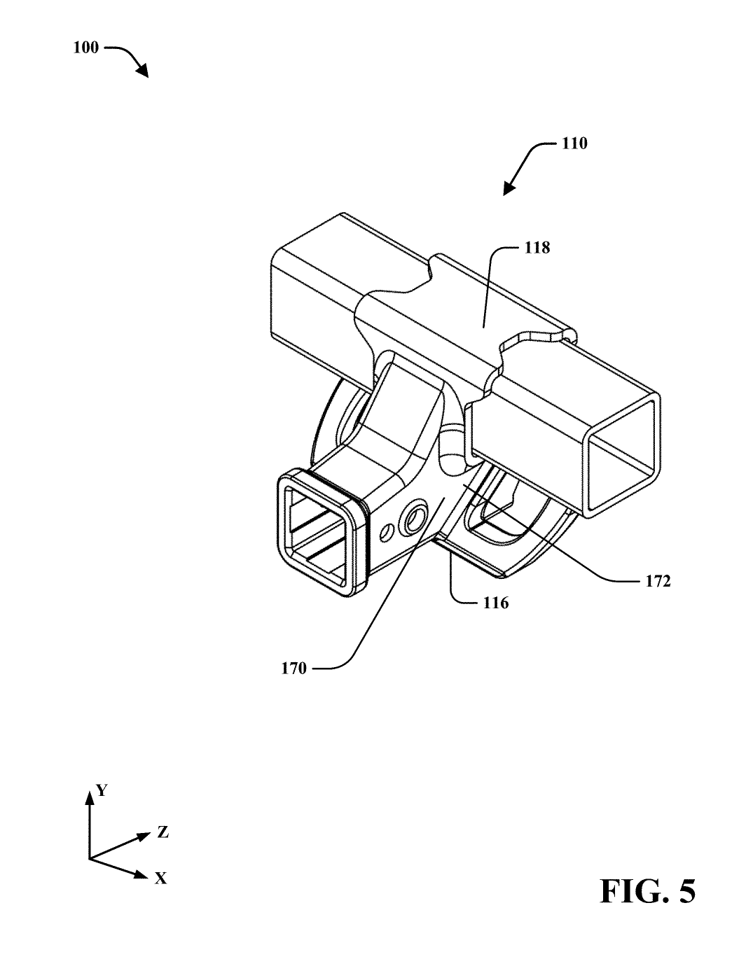

A further embodiment of the hitch receiver assembly 110 is shown in FIG. 5. In this embodiment, the hitch receiver assembly 110 may include a height adapting portion 170. The height adapting portion 170 may extend downwardly from a top side 118 to the bottom side 116. It will be understood that the height adapting portion 170 may be a generally triangular shape such that the hitch receiver assembly 110 may form a generally L-shaped configuration. In some embodiments as best shown in FIGS. 6A and 6C, the height adapting portion 170 may further include reinforcing cross members 172. The reinforcing cross members 172 may be incorporated along the portions of the hitch receiver assembly 110 both at its crossbar side 112 and in/proximate to the structure at the bottom side 116. Notably, the height adapting portion 170 may be associated with the elevation change in order to further accommodate the distribution of load along the entirety of the hitch receiver assembly 110. The height adapting portion 170 may provide strength to the hitch receiver assembly 110. The height adapting portion 170 and the reinforcing cross members 172 may be monolithically formed with the body 120. They may be formed monolithically such as through casting.

As best shown in FIGS. 6A and 6C, the hitch receiver assembly 110 may further include a cross-sectional reinforcing member 180 that may be incorporated along the edges of the hitch receiving portion 140 in/proximate to the structure at the hitch receiving side 114. Notably, the cross-sectional reinforcing member 180 may reinforce the hitch receiving portion 140 such that the hitch receiving portion 140 may be capable of handling additional loads. The cross-sectional reinforcing member 180 may be formed from higher strength material. The cross-sectional reinforcing member 180 may be of any appropriate configuration. In some embodiments, the cross-sectional reinforcing member 180 may be monolithically formed with the hitch receiving portion 140 such as through casting.

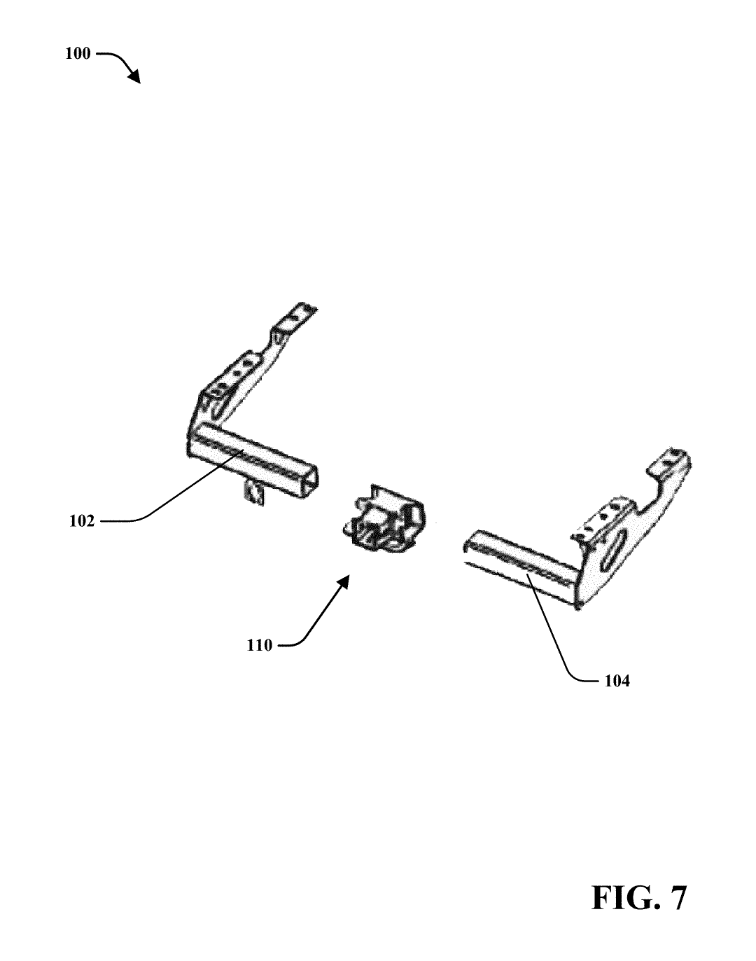

In assembly operation shown in FIG. 7, the crossbar members 102, 104 and the hitch receiver assembly 110 may be formed separately. The hitch receiver assembly 110 may be positioned adjacent to the crossbar members 102, 104. The crossbar members 102, 104 may be inserted into the hitch receiver assembly 110 to be formed through a subsequent forming operation, such as welding the components together for the hitch system 100. Any appropriate product may be attached with hitch receiver assembly 110 without departing from the present teachings.

More specifically, the hitch receiver assembly 110 may be formed as a monolithic unitary piece such as through casting. The elements described above for the hitch receiver assembly 110 may be formed entirely as a monolithic unitary piece. In such embodiments, the hitch receiver assembly 110 may be formed entirely through casting such that no portion thereof is welded. In other words, the entire hitch receiver assembly 110 may be formed without having to weld any components or parts thereto. Still further, while casting is described above, the hitch receiver assembly 110 may also be forged, 3D printed or any such process whereby the hitch receiver assembly 110 is formed monolithically as a unitary member.

To assemble the hitch system 100, the crossbar members 102, 104 may be inserted into the crossbar receiving ends 132, 134. Once operatively positioned, the attachment profiles 133, 136 may be in their operative position relative to the crossbar members 102, 104. The hitch receiver assembly 110 may be welded to the crossbar members 102, 104. Specifically, the hitch receiver assembly 110 may be welded to the crossbar members 102, 104 at the attachment profiles 133, 136. This may be the only welding that occurs during the production of the hitch system 100 as the hitch receiver assembly 110 may not have any components or parts welded thereto. The attachment profiles 133, 136 may provide an outline for the welding process, i.e., the producer may follow the profile of the attachment profiles 133, 136 in welding the crossbar members 102, 104 with the hitch receiver assembly 110. This may result in a weld profile between the crossbar members 102, 104 and the hitch receiver assembly 110 that is non-linear. Or more specifically, the weld profile crossbar receiving ends 132, 134 is of substantially the same shape as the attachment profiles 133, 136. This non-linear weld provides a stronger connection between the crossbar members 102, 104 and the hitch receiver assembly 110 resulting in higher load ratings for the end product. This also allows the hitch system 100 or more specifically, the hitch receiver assembly 110 to utilize less material than prior art systems. This may result in a less expensive and lighter end product or an end product of essentially the same weight and material that is able to handle higher loads than the corresponding prior art versions.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Having thus described the invention, we claim:

1. A hitch receiver assembly comprising:
a body;
a hitch receiving portion comprising an opening and extending from the body;
a crossbar receiving portion extending from the body opposite the hitch receiving portion, wherein the crossbar receiving portion comprises opposed crossbar receiving openings, each of the crossbar receiving openings having a non-linear attachment profile.

2. The hitch receiver assembly of claim 1, wherein the body, hitch receiving portion and crossbar receiving portion are a unitary member.

3. The hitch receiver assembly of claim 1, wherein the body, hitch receiving portion and crossbar receiving portion are monolithically formed as a unitary member.

4. The hitch receiver assembly of claim 1 further comprising a safety chain tie-down member attached with the body.

5. The hitch receiver assembly of claim 4, wherein the body, hitch receiving portion, crossbar receiving portion and safety chain tie-down member are monolithically formed as a unitary member

6. The hitch receiver assembly of claim 5, wherein the body, hitch receiving portion, crossbar receiving portion and safety chain tie-down member are free of any welding.

7. The hitch receiver assembly of claim 1, wherein each of the attachment profiles comprise a first portion running generally perpendicular to the cross bar receiving portion and a second portion that curves inward toward a center axis of the body.

8. The hitch receiver assembly of claim 7, wherein each of the attachment profile further comprise a third portion running from the second portion, whereby the third portion is perpendicular to the cross bar receiving portion.

9. The hitch receiver assembly of claim 8, wherein each of the attachment profiles further comprise a fourth portion running from the third portion, whereby the fourth portion comprises a curved portion curving away from the center axis.

10. The hitch receiver assembly of claim 9, wherein each of the attachment profiles further comprise a fifth portion running from the fourth portion, whereby the fifth portion is perpendicular to the cross bar receiving portion.

11. The hitch receiver assembly of claim 1, wherein each of the non-linear attachment profiles a similar in shape.

12. A hitch system comprising:
the hitch receiver assembly of claim 1;
first and second crossbar members inserted into the crossbar receiving openings and welded along the attachment profiles.

13. A hitch system comprising:
a hitch receiver assembly comprising:
a body;
a hitch receiving portion comprising an opening and extending from the body;
a crossbar receiving portion extending from the body opposite the hitch receiving portion, wherein the crossbar receiving portion comprises a crossbar receiving opening, the crossbar receiving opening having a non-linear attachment profile;
a crossbar member inserted into the crossbar receiving opening and welded along the attachment profile attaching the crossbar member with the hitch receiver assembly.

14. The hitch system of claim 13, wherein the attachment profile comprises a first portion running generally perpendicular to the cross bar receiving portion and a second portion that curves inward toward a center axis of the body.

15. The hitch receiver assembly of claim 14, wherein the attachment profile further comprises a third portion running from the second portion, whereby the third portion is perpendicular to the cross bar receiving portion.

16. The hitch receiver assembly of claim 15, wherein the attachment profile further comprises a fourth portion running from the third portion, whereby the fourth portion comprises a curved portion curving away from the center axis.

17. The hitch receiver assembly of claim 16, wherein the attachment profile further comprises a fifth portion running from the fourth portion, whereby the fifth portion is perpendicular to the cross bar receiving portion.

18. The hitch system of claim 13 further comprising a second crossbar receiving opening on an opposite side of the crossbar receiving portion from the crossbar receiving opening, wherein the second crossbar receiving opening comprises a non-linear second attachment profile.

19. The hitch system of claim 18 further comprising a second crossbar member inserted into the second crossbar receiving opening, wherein the second crossbar member is welded along the second attachment profile attaching the second crossbar member with the hitch receiver assembly.

20. The hitch system of claim 13, wherein the body, hitch receiving portion and crossbar receiving portion are monolithically formed as a unitary member.
